(19) United States
(12) Patent Application Publication
(10) Pub. No.: US 2025/0033739 A1
(43) Pub. Date: Jan. 30, 2025

(54) REDUCTION RATIO CHANGING DEVICE

(71) Applicants: CENTRE NATIONAL DE LA RECHERCHE SCIENTIFIQUE, Paris (FR); UNIVERSITE DE POITIERS, Poitiers Cedex (FR); CREPS DE POITIERS, Vouneuil-Sous-Biard (FR)

(72) Inventors: Jean-François DEBRIL, Poitiers (FR); Antoine EON, Poitiers (FR); Loïc FRECHE, Chasseneuil-Du-Poitou (FR); Michael BEAU, Saint Georgees Les Baillargeaux (FR); Mathieu DOMALAIN, Poitiers (FR); François DURAND, Liguge (FR)

(21) Appl. No.: 18/706,971

(22) PCT Filed: Nov. 2, 2022
(86) PCT No.: PCT/EP2022/080490

§ 371 Date: May 2, 2024

(30) Foreign Application Priority Data
Nov. 2, 2021 (FR) 2111624

(51) Int. Cl. B62M 9/08; B62M 9/00; F16H 55/12; F16H 55/30

(52) U.S. Cl. CPC B62M 9/08; F16H 55/12; F16H 55/30; B62M 2009/002

(57) ABSTRACT

A reduction ratio changing device, so-called DCRR, for a mechanical chain transmission system includes a toothing. The toothing of the DCRR includes a portion, so-called the helical portion, forming a toothed helix winding around an axis of revolution of the DCRR and a portion, so-called the circular portion, forming a toothed planar circle whose centre coincides with the axis of revolution of the DCRR. The helical portion of the toothing extends from a distal end of the toothing of the DCRR towards the circular portion of the toothing. The circular portion of the toothing of the DCRR forms a proximal end of the toothing of the DCRR.

The present application is a U.S. National Phase of International Application Number PCT/EP2022/080490, filed Nov. 2, 2022, which claims priority to French Application No. 2111624, filed Nov. 2, 2021.

### TECHNICAL FIELD

The present invention relates to the technical field of mechanical transmission systems. In particular, the invention relates to mechanical transmission systems comprising two pinions connected by a chain.

The invention relates to a reduction ratio change device for mechanical transmission systems and, in particular, for chain transmission systems. In particular, yet not exclusively, the invention relates to mechanical transmission systems for bicycles.

### PRIOR ART

Motors have an optimum operating speed at which they output a maximum of power. This also applies to human biomechanics in that there is a muscle elongation-shortening speed for which the power generation is optimum. This results in an optimum joint rotational speed or rotation rate, for example of pedalling, allowing generating a maximum mechanical power at the crankset.

In order to optimise the transmission of the produced mechanical power to the wheel(s), the transmission ratio between the output rotational speed and the input rotational speed is modulated so as to adapt the resistance or the torque at the input and the input rotational speed with the objective of getting closer to the maximum efficiency point of the system producing the mechanical power.

The transmission ratio is defined as the ratio between the output rotational speed and the input rotational speed. In the case of a transmission by means of a gear, the transmission ratio may also be defined as the ratio between the radius of the input gear wheel, or the number of teeth of the input gear wheel, and the radius of the output gear wheel, or the number of teeth of the output gear wheel.

Various transmission ratio changing devices are known from the prior art allowing reaching and maintaining optimum operating regimes. Among these devices, gearboxes, continuous variable transmissions and derailleurs are primarily known.

As regards bicycles, the existing technologies essentially include derailleurs which equip most bicycles, gear hubs, gearboxes, and continuous variable transmission (CVT) systems.

Derailleurs consist of a series of pinions, or toothed wheels, and a mechanical guide device enabling the chain to pass from one to the other in order to vary the transmission ratio.

The passage from one plate to another results in discontinuities particularly destabilising the pedalling of the cyclist and unfavourable to performance.

Similarly, the passage from one plate to another is done hardly under load, i.e. when a large torque is applied to the drive shaft. Therefore, the use of a derailleur constrains the cyclist to release, however briefly, his/her effort while switching from one pinion to another.

Derailleurs, whether equipped with an electric motor or not, require a manual intervention by the operator, which consists in actuating a lever or a button. This intervention proves to be destabilising, in particular during a stopped start in a BMX Race for example.

The same constraints apply to gear hub systems to which a significant mass is added which is detrimental to performance.

Gearboxes enable a change in the reduction ratio under load but keep the discontinuity problem.

CVTs equip both industrial devices and consumer bicycles. For a CVT, the integrated gear mechanism inside the hub is replaced by trapezoidal belts or friction mechanisms or other complex mechanisms. One of the CVT currently marketed for cycling is based on a ball system that enables a continuous change in the transmission ratio. Nevertheless, these devices have a large mass and a low transmissible torque/mass ratio.

The present invention aims to overcome, at least in part, the drawbacks of the devices of the prior art.

The invention further aims:
to propose a reduction ratio change device, so-called DCRR, enabling a variation in the reduction ratio:
continuous, and/or
with no discontinuity, and/or
under mechanical load, and/or
with no decrease in the applied force torque, and/or
automatic, i.e. with no manual intervention, and/or
to propose a modular DCRR, and/or
to propose a DCRR whose reduction ratio and/or variation of the reduction ratio could be modified or modulated, directly on site, simply and quickly, and/or
to propose a DCRR comprising a small number of mechanical parts, and/or
to propose a DCRR guaranteeing a high operating reliability, and/or
to propose a DCRR requiring no or little maintenance.

### SUMMARY

To this end, a reduction ratio changing device, so-called DCRR, for a mechanical chain transmission system is proposed. The DCRR comprises a toothing. The toothing of the DCRR comprises a portion, so-called the helical portion, forming a toothed helix wound around an axis of revolution of the DCRR. The helical portion of the toothing extends from a distal, or respectively proximal, end of the toothing of the DCRR towards a proximal, or respectively distal, end of the toothing of the DCRR.

Preferably, the toothing of the DCRR further comprises a portion, so-called the circular portion, forming a toothed planar circle, whose centre coincides with the axis of revolution of the DCRR and the helical portion of the toothing extending from the distal, or respectively proximal, end of the toothing of the DCRR towards the circular portion of the toothing, said circular portion of the toothing forming the proximal, or respectively distal, end of the toothing of the DCRR.

Preferably, the DCRR forms or consists of all or part of a pinion. Still preferably, the DCRR forms or consists of all or part of a drive pinion. Preferably, the DCRR forms or consists of all or part of a pinion of a bicycle.

By a mechanical transmission system, it could be understood a drive system.

Preferably, the toothing of the DCRR is intended to be meshed from its distal end up to its proximal end.

The toothing may consist of, at least, the helical portion and the circular portion. Preferably, the toothing consists of the helical portion and of the circular portion.

By helix, it could be understood a spiral. The helix may be circular, elliptical, conical, parabolic or hyperbolic.

Preferably, the toothed helix is not and does not comprise a concentric portion or a circle, i.e. a circle comprised in a plane having a centre of rotation.

The helix may be inscribed or wound around an axisymmetric cylinder or an axisymmetric cone.

By “end”, it could be understood a terminal tooth or an initial tooth of a toothing. By end of the toothing or end of a portion or part of the toothing, it could be understood an end tooth, for example a terminal or initial tooth, of the toothing of the DCRR or of a portion or part of the toothing DCRR.

The terms “distal” and “proximal” are defined with respect to a midplane or sagittal plane of an object, for example of a vehicle, preferably of a bike, on which the DCRR is intended to be mounted and/or on which the mechanical transmission system is intended to be mounted. Preferably, the midplane comprises an axis extending between the front and the rear of the object on which the DCRR is intended to be mounted and/or on which the mechanical transmission system is intended to be mounted. Preferably, the midplane comprises a vertical axis when the object is in the running position and/or rests on its wheels.

The toothing of the DCRR extends from a distal end of the toothing of the DCRR, which also forms the distal end of the helical portion, up to a proximal end of the toothing of the DCRR, which forms the circular portion.

Preferably, the helical portion of the toothing extends from the distal end of the toothing of the DCRR up to a proximal end of the helical portion. Preferably, the proximal end of the helical portion is adjacent to or contiguous to or located opposite the circular portion. Preferably, the proximal end of the helical portion is the last element, preferably the last tooth, of the helical portion meshed before the circular portion is meshed, i.e. the proximal end of the toothing of the DCRR.

Preferably, the helical portion is continuous. Still preferably, the helical portion is wound continuously over its entire length. Even more preferably, the helical portion is wound continuously from the distal end of the helical portion up to the proximal end of the helical portion. Preferably, the proximal end of the helical portion corresponds to or consists of the tooth of the helix located or positioned the closest to the circular portion, i.e. the planar circle.

Preferably, the proximal end of the toothing of the helical portion has a radius identical to a radius of the toothing of the circular portion.

Preferably, the toothing of the DCRR preferably consists of the toothing of the helical portion and the toothing of the circular portion.

Preferably, the axis of the helix is coincident with the axis of revolution of the DCRR.

The fact that the helical portion is composed of one single helix and/or the uninterrupted and/or continuous nature of the helix of the helical portion enables a continuous winding and/or meshing, of the chain with which the DCRR is intended to be meshed, with the helix of the helical portion. Thus, the transmission of the effort to a chain with which the DCRR is intended to be meshed is ensured without overlapping or jerking. Furthermore, the variation or the change in the reduction ratio is carried out under load and without jerking and that being so as soon as the transmission of the effort to the DCRR is initiated.

By “under load” or “under loading” or “under mechanical load” or “under mechanical loading”, it could be understood the application of a force, such as, for example, a force torque. Thus, by “change in the reduction ratio under load”, it could be understood the modification of the reduction ratio of the DCRR concomitantly with the application of a force, in particular of a force torque, on the DCRR.

Preferably, the DCRR is arranged so as to be rotated by application of a force torque on the DCRR. Preferably, the DCRR is intended to be coupled with a pinion, preferably a driven pinion. Preferably, the DCRR is intended to transmit the force torque, which is applied thereto, to the pinion, preferably to the driven pinion, by means of the chain with which the DCRR is intended to be meshed.

The reduction ratio and/or the variation in the reduction ratio of the DCRR may be modified or modulated by modifying or modulating parameters of the DCRR, so-called the adjustment parameters of the DCRR. Preferably, the adjustment parameters of the DCRR are an initial and/or final radius of the toothing of the DCRR and/or a number of turns of the helix and/or a number of teeth of the toothing and/or of portions of the toothing and/or a directrix curve of the helix and/or a variation in the radius of the helix and/or a variation in the directrix curve of the helix.

The adjustment parameters of the DCRR, and consequently the reduction ratio, may be modulated according to parameters, so-called the customisation parameters, such as an optimum rate and/or an optimum initial and/or final drive rotational speed and/or an optimum initial and/or final drive load. In some cases, the adjustment parameters of the DCRR, and consequently the reduction ratio, may, complementarily or alternatively, be modulated according to parameters of the terrain, such as, by way of example, the topography and/or the pathway and/or the level difference. The customisation parameters may depend on and/or may be determined based on, or according to, the parameters of the terrain.

The number of teeth of the helical portion may be greater than the number of teeth of the circular portion.

Preferably, the radius of the helical portion is constant over at least one section, so-called the first section, of the helical portion and/or, preferably, the radius of the helical portion varies over at least one section, so-called the second section, of the helical portion.

Preferably, the radius of the helical portion is constant, preferably only, over the first section. Preferably, the radius of the helical portion varies, preferably only, over the second section.

Preferably, the toothing of the helical portion comprises, preferably consists of, the toothing of the first section of the helical portion and the toothing of the second section of the helical portion.

The proximal end of the toothing of the first section of the helical portion of the DCRR may have the same radius as the distal end of the toothing of the second section of the helical portion of the DCRR.

Preferably, the proximal end of the toothing of the first section of the helical portion adjoins and/or is contiguous and/or is located opposite the distal end of the toothing of the second section of the helical portion. Preferably, the proximal end of the first section of the helical portion is the last element, preferably the last tooth, of the first section of the helical portion meshed before the distal end is meshed, preferably the first tooth, of the second section of the helical portion.

Preferably, an end portion of the proximal turn of the first section of the helical portion and an end portion of the distal turn of the second section of the helical portion are aligned and/or tangent so as to forming a helix or a continuous winding. By “turn”, it could be understood a turn of an helix or a spiral.

Preferably, the proximal end, preferably the last tooth, of the second section of the helical portion corresponds to or consists of the proximal end of the helical portion of the DCRR.

Preferably, the proximal end of the toothing of the second section of the helical portion has the same radius as the radius of the toothing of the circular portion.

When the first and second sections of the helical portion are aligned, a continuous winding and/or meshing, of the helical portion with the chain with which the DCRR is intended to be meshed, is ensured. Thus, the transmission of the effort to the chain, with which the DCRR is intended to be meshed, is ensured without overlapping or jerking. Furthermore, the variation in the reduction ratio is carried out under load, continuously and smoothly and that being so as soon as the transmission of the effort to the DCRR is initiated.

The number of turns over which the radius of the first section of the helical portion is constant may be adapted according to one or more customisation parameter(s) so that the optimum drive rotational speed is reached when meshing of the distal end of the second section of the helical portion is completed.

When the radius of the first section of the helical portion is constant, the rotational speed of the DCRR is rapidly increased, and that being so as soon as the transmission of the effort to the DCRR is initiated, while keeping the transmission ratio constant.

When the radius of the second section of the helical portion is variable, the transmission ratio is modified so as to vary the power generated while keeping the optimum drive rotational speed and/or the optimum drive load.

Preferably, the toothed helix of the first section of the helical portion is wound at least one turn and a half around the axis of revolution of the DCRR.

In other words, the toothing of the first section of the helical portion forms a spiral which could comprise at least one turn and a half turn.

The radius of the second section of the helical portion may increase along the axis of revolution according to a direction extending from a distal end of the toothing of the second section of the helical portion towards a proximal end to the toothing of the second section of the helical portion.

The number of turns over which the radius of the second section of the helical portion varies may be adapted according to one or more customisation parameter(s) so that the variation in the transmission ratio, performed on the second section of the helical portion, takes place at the appropriate time point in order to ensure that the optimum drive rotational speed and/or the optimum drive load are maintained.

Increasing the radius of the second section of the helical portion allows increasing the transmission ratio to increase the generated power, by approaching the maximum efficiency point of the system, for example a motor or a human, while developing the optimum drive rotational speed and/or the optimum drive load.

By drive load, it could be understood the force torque applied to the DCRR.

The device may comprise a guide arranged between the proximal end of the toothing of the helical portion and the toothing of the circular portion, said guide being arranged so as to ensure and/or to assist in and/or contribute to a continuous meshing, of the chain with which the DCRR is intended to be meshed, from the helical portion towards the circular portion.

Preferably, the guide is further arranged between the helical portion and the circular portion.

Preferably, the guide extends primarily according to a plane parallel to an end portion of the proximal turn of the second section of the helical portion.

The guide allows ensuring that the transmission of the force, to the chain with which the DCRR is intended to be meshed, without overlapping or jerking. Furthermore, the guide enables a transition or a passage, from the helical portion towards the circular portion, under load and without jerking.

Preferably, the toothing of the circular portion comprises a recess of at least one tooth opposite which the guide is arranged.

Preferably, the recess comprises at least two teeth. Still preferably, the recess comprises three teeth or more.

The recess allows ensuring that there no overlap or friction between the teeth of the circular portion and the chain with which the DCRR is intended to be meshed. Thus, a minimum decrease in the reduction efficiency is ensured and no jerks are observed.

The recess allows minimising mechanical clearances during the transition or passage from the helical portion towards the circular portion.

Preferably, a portion, still preferably at least one portion, of a proximal surface of the guide is arranged so as to ensure guidance of the chain, with which the DCRR is intended to be meshed, from the helical portion towards the circular portion.

By proximal surface of the guide, it could be understood the surface located opposite the circular portion.

Preferably, the guide is arranged so as to move and/or guide the chain according to the axis of the DCRR and in the distal to proximal direction, i.e. in the direction extending from the distal section of the DCRR towards the proximal section of the DCRR.

The guide may be arranged and/or positioned and/or disposed so that the chain exerts a friction on the guide, preferably on the proximal surface of the guide, during passage thereof from the helical portion towards the circular portion.

The guide, preferably the proximal surface, may be arranged so as to prevent the return of the chain to the helical portion, when the chain is meshing with the circular portion.

The device may comprise a set of contiguous orifices equidistant from the axis of revolution of the DCRR, symmetrical in pairs with respect to the axis of revolution of the DCRR being arranged so as to ensure fastening of transmission elements on the DCRR; the transmission elements are intended to be fastened on the DCRR and to transmit the force torque to the DCRR.

Preferably, the set of orifices forms an annular band.

Preferably, the centres of the orifices are located equidistant from the axis of revolution of the DCRR.

Preferably, the orifices pass through the DCRR, or one or more wall(s) of the DCRR or of a mechanical part or mechanical element of the DCRR, when the DCRR comprises an assembly of parts, preferably one or more wall(s), whose thickness extends according to the axis of revolution of the DCRR, according to the direction according to which the axis of revolution of the DCRR extends.

Preferably, the DCRR comprises an opening, so-called the central opening, having as the centre the axis of revolution of the DCRR, and, preferably, the orifices of the set of orifices of the DCRR border the central opening.

The set of orifices allows adjusting or adapting the angular position, or positioning, of the transmission elements, intended to be fastened on the DCRR and intended to transmit a force torque to the DCRR.

The angular position, or the positioning, of transmission elements may be adjusted or adapted with respect to:
the distal, or proximal, end of the toothing of the DCRR, and/or
the proximal end of the toothing of the first section of the helical portion and/or the distal end of the toothing of the second section of the helical portion.

The transmission elements may consist of levers or cranks.

Preferably, each of the circular portion and the helical portion is part of a distinct part, or mechanical part or mechanical element, said distinct parts are arranged so as to be reversibly assembled, by fastening means, in one piece so as to form the DCRR; the part comprising the circular portion is so-called the proximal wheel and the part comprising the helical portion is so-called the distal wheel.

Preferably, the central section of the wheels may be hollowed.

Preferably, the helical portion forms or consists of an annular peripheral section of the distal wheel. Preferably, the distal wheel has a cylindrical or conical base.

Preferably, the circular portion forms or consists of an annular peripheral section of the proximal wheel. Preferably, the proximal wheel is a disc.

The fact that the helical and circular portions belong to two distinct parts that could be assembled in a reversible manner makes the DCRR modular.

The fact that the helical and circular portions belong to two distinct parts also allows replacing or changing, on site, simply and quickly, one of the portions while keeping the other portion not replaced. Thus, according to one or more customisation parameter(s), it is possible to simply and quickly modify or modulate the reduction ratio and/or the variation of the reduction ratio of the helical portion while keeping the reduction ratio of the circular portion constant, or vice versa. Of course, the modification of the two portions at the same time allows modifying the reduction ratio of each of the portions simultaneously.

The distal wheel may comprise a set of contiguous apertures equidistant from the axis of revolution of the DCRR and symmetrical in pairs with respect to the axis of revolution of the DCRR.

The proximal wheel may comprise a set of contiguous apertures equidistant from the axis of revolution of the DCRR and symmetrical in pairs with respect to the axis of revolution of the DCRR.

Each of the apertures of the set of apertures of the proximal wheel, or respectively of the distal wheel, may have a curved shape extending according to a circle arc parallel to the circular portion. A radius of the circle arc according to which the apertures of the set of apertures of the proximal wheel, or respectively of the distal wheel, extend, may be equal to a distance between the axis of revolution of the DCRR and the centres of the apertures of the set of apertures of the distal wheel, or respectively of the proximal wheel, so as to adjust an angular position, or positioning, of the proximal wheel relative to the distal wheel, or vice versa, preferably during assembly of the distal wheel with the proximal wheel. Hence, the set of apertures allows positioning the proximal and distal wheels relative to one another without effort and without adjustment. Thus, the assembly of the distal and proximal wheels is facilitated and made reliable.

By aperture, it could be understood an opening.

The set of apertures of the proximal, or respectively distal, wheel having a curved shape may form an annular band. Preferably, the centres of the apertures may be located along an annular band.

Preferably, the centres of the apertures are located equidistant from the axis of revolution of the DCRR.

Preferably, the set of apertures pass through the proximal and distal wheels, or one or more walls, preferably the thickness of which extends according to the axis of revolution of the DCRR, of the proximal and distal wheels, according to the direction according to which the axis of revolution of the DCRR extends.

The proximal wheel may comprise the set of orifices of the DCRR. Preferably, the orifices of the set of orifices of the DCRR are formed in the proximal wheel.

The apertures of the set of apertures of the proximal wheel may have an oblong shape. A length of the oblong shaped apertures may extend according to a circle arc parallel to the circular portion.

By angular position, or angular positioning, it could be understood the positioning of the circular portion, or of the toothing of the circular portion, relative to the helical portion, or to the toothing of the helical portion.

The fastening means, such as for example screws and nuts, are arranged so as to cooperate with the apertures of the proximal wheel and of the distal wheel.

The adjustment of the position of the proximal wheel relative to the distal wheel allows replacing or changing, on site, simply and quickly, the distal wheel or the proximal wheel while keeping the other wheel not replaced. Hence, the adjustment of the position of the proximal wheel relative to the distal wheel allows modifying or modulating, on site as needed, the reduction ratio of the distal wheel while preserving the reduction ratio of the proximal wheel or vice versa.

The distal wheel of the DCRR may comprise a central opening and the proximal wheel of the DCRR may comprise a radial projection, or vice versa, the radial projection forming a ring comprising a radial peripheral wall, said ring forming an extra thickness, so-called lateral extra thickness, extending according to the axis of revolution of the DCRR, of the proximal wheel, or respectively of the radial wheel, and being arranged so as to be inserted into the central opening of the distal wheel, or respectively of the proximal wheel; the radial peripheral wall is arranged so as to be supported bearing and/or fitted and/or centred on the walls of the distal wheel, or respectively of the proximal wheel, delimiting the central opening of the distal wheel, or respectively of the proximal wheel.

Preferably, the central opening of the DCRR corresponds to or consists of the central opening of the distal wheel, or respectively of the proximal wheel.

Preferably, each of the proximal wheel and/or the distal wheel comprises a central opening.

Preferably, the central opening of the DCRR may comprise or may correspond or may consist of the central opening of the distal wheel and the central opening of the proximal wheel.

The radial peripheral wall may be defined as a circular external wall.

The ring may be defined as a disc projecting with respect to the surface of the wheel extending according to a plane perpendicular to the axis of revolution of the DCRR. The ring may be defined as a disk projecting according to the axis of revolution of the DCRR. The ring may be defined as a disc projecting according to the direction connecting the proximal wheel to the distal wheel of the DCRR.

The lateral extra thickness may extend across the thickness of the wheel. The lateral extra thickness may extend according to the axis of revolution of the DCRR. The lateral extra thickness of the proximal wheel may extend according to the axis of revolution of the DCRR. The lateral extra thickness of the proximal wheel may extend according to the direction connecting the proximal wheel to the distal wheel.

The radial projection may be defined as a circular shoulder formed by an outer wall of a disc, the disc forming a lateral extra thickness of the wheel.

The guide may be reversibly fastened, by fastening means, on the proximal wheel, or respectively on the distal wheel, and the distal wheel, or respectively the proximal wheel, comprises a notch arranged so as to accommodate, at least in part, in whole or in part only, the guide.

Preferably, the means for fastening the guide on the proximal wheel may be identical to the means for fastening the proximal and distal wheels together. The means for fastening the guide on the proximal wheel may be different from the means for fastening the proximal and distal wheels together.

Preferably, the guide extends radially, i.e. according to the direction perpendicular to the axis of revolution of the DCRR, beyond the toothing of the DCRR. Preferably, the guide extends between the proximal end of the helical portion, preferably between the proximal end of the toothing of the helical portion, and the circular portion.

Preferably, the distal wheel is formed of two distinct parts, one of the two parts, so-called the starter wheel, comprises the first section of the helical portion and the other of the two parts, so-called the intermediate wheel, comprises the second section of the helical portion.

Preferably, the first section of the helical portion forms or consists of an annular peripheral section of the starter wheel.

Preferably, the second section of the helical portion forms or consists of an annular peripheral section of the intermediate wheel.

Preferably, each of the starter wheel and/or the intermediate wheel and/or the distal wheel comprises a central opening.

Preferably, the central opening of the DCRR may comprise or may correspond to or may consist of the central opening of the starter wheel, the central opening of the intermediate wheel and the central opening of the proximal wheel.

The fact that the first and second sections of the helical portion belong to two distinct parts that could be reversibly assembled makes the DCRR modular.

The fact that the first and second sections of the helical portion belong to two distinct parts also allows replacing or changing, on site, simply and quickly, one of the sections while keeping the other section not replaced. Thus, according to one or more customisation parameter(s), it is possible:
to change, on site, simply and quickly the starter wheel, i.e. to modify or modulate the toothing of the starter wheel, for example by changing the number of teeth or the number of turns of the toothing of the starter wheel, while keeping the reduction ratio of the intermediate wheel and the reduction ratio of the proximal wheel, in other words to modify or modulate, on site, simply and quickly the first section of the helical portion, for example by changing the number of teeth or the number of turns of the toothing of the first section of the helical portion without changing the reduction ratio of the second section of the helical portion or the reduction ratio of the circular portion, or
to change, on site, simply and quickly the starter wheel, i.e. to modify or modulate the toothing of the starter wheel, for example by changing the number of teeth and/or the number of turns of the toothing of the starter wheel, while modifying the reduction ratio of the intermediate wheel and while keeping or modifying the reduction ratio of the proximal wheel, in other words to modify or modulate, on site, simply and quickly the first section of the helical portion, for example by changing the number of teeth and/or the number of turns of the toothing of the first section of the helical portion and by changing the reduction ratio of the second section of the helical portion by changing or keeping the reduction ratio of the circular portion, or
to change, on site, simply and quickly the intermediate wheel, i.e. to modify or modulate the toothing of the intermediate wheel, for example by changing the number of teeth and/or the number of turns of the toothing of the intermediate wheel, while keeping, or respectively while changing, the reduction ratio of the intermediate wheel and while changing, or respectively while keeping, the reduction ratio of the proximal wheel, in other words to modify or modulate, on site, simply and quickly the second section of the helical portion, for example by changing the number of teeth and/or the number of turns of the toothing of the second section of the helical portion and keep, or respectively modify, the reduction ratio of the second section of the helical portion and modify, or respectively keep, the reduction ratio of the circular portion, or
to change, on site, simply and quickly the proximal wheel, i.e. to modify or modulate the toothing of the intermediate wheel, for example by changing the number of teeth of the intermediate wheel, and change the intermediate wheel while keeping the reduction ratio of the starter wheel, in other words to modify or modulate, on site, simply and quickly the circular portion, for example by changing the number of teeth and to change the second section of the circular portion while keeping the reduction ratio of the first section of the helical portion.

Of course, the modification of the first and second sections of the helical portion at the same time or the modification of the first and second sections of the helical portion as well as of the circular portion allows modifying the reduction ratio of each of the section simultaneously.

Each of the starter wheel and the intermediate wheel may comprise a set of contiguous apertures equidistant from the axis of revolution of the DCRR and symmetrical in pairs with respect to the axis of revolution of the DCRR; a distance between the axis of revolution of the DCRR and the centres of the apertures of the set of apertures of the starter wheel is equal to a distance between the axis of revolution of the DCRR and the centres of the apertures of the set of apertures of the intermediate wheel.

Preferably, the starter wheel comprises a proximal end wall and/or the intermediate wheel comprises proximal and distal end walls.

Preferably, the proximal end wall of the distal wheel, the proximal end wall of the starter wheel and the distal and proximal end walls of the intermediate wheel extend radially relative to the axis of revolution of the DCRR.

Preferably, the axis of revolution of the DCRR is comprised in a plane according to which the proximal end wall of the distal wheel extends, in a plane according to which the proximal end wall of the starter wheel extends, in a plane according to which the distal end wall of the intermediate wheel extends and in a plane according to which the proximal end wall of the intermediate wheel extends.

Preferably, the distal end wall of the proximal wheel, the proximal end wall of the distal wheel, the proximal end wall of the starter wheel and the distal and proximal end walls of the intermediate wheel extend from, respectively, the distal end of the toothing of the circular portion, the proximal end of the toothing of the helical portion, the proximal end of the toothing of the first section of the helical portion and the distal and proximal ends of the toothing of the second section of the helical portion in the direction of the axis of revolution of the DCRR.

Preferably, the distal end wall of the proximal wheel, the proximal end wall of the distal wheel, the proximal end wall of the starter wheel and the distal and proximal end walls of the intermediate wheel extend, respectively, from a base of the distal end of the toothing of the circular portion, a base of the proximal end of the toothing of the helical portion, a base of the proximal end of the toothing of the first section of the helical portion and of respective bases of the distal and proximal ends of the toothing of the second section of the helical portion in the direction of the axis of revolution of the DCRR. Preferably, the bases of the ends are successive to the ends with respect to the winding direction of the chain with which the DCRR is intended to be meshed

Preferably, the end walls of the proximal, distal, starter and/or intermediate wheels are comprised in a plane that comprises the axis of revolution of the DCRR.

Preferably, the proximal end wall of the second section of the helical portion is arranged so as to cooperate and/or be supported in abutment with the distal end wall of the first section of the helical portion. Preferably, the proximal end wall of the starter wheel is arranged so as to cooperate and/or be brought into abutment with the distal end wall of the intermediate wheel.

Preferably, the intermediate wheel, and/or the second section of the helical portion, comprises a wall, so-called the complementary wall, comprised in the same plane as the plane in which the distal end wall of the intermediate wheel extends, and/or of the second section of the helical portion. The complementary wall of the intermediate wheel, and/or of the second section of the helical portion, is located on the opposite side of the intermediate wheel, and/or of the second section of the helical portion, with respect to the axis of revolution of the DCRR.

Preferably, the starter wheel, and/or the first section of the helical portion, comprises a wall, so-called the complementary wall, comprised in the same plane as the plane in which the proximal end wall of the starter wheel extends, and/or of the first section of the helical portion. The complementary wall of the starter wheel, and/or of the first section of the helical portion, is located on the opposite side of the starter wheel, and/or of the first section of the helical portion, with respect to the axis of revolution of the DCRR.

Preferably, the distal end wall and the complementary wall of the intermediate wheel, and/or of the second section of the helical portion, are arranged so as to cooperate and/or be brought into abutment with the proximal end wall and the complementary wall of the starter wheel, and/or the first section of the helical portion.

The set of apertures of the starter wheel and the set of apertures of the intermediate wheel may form or correspond to or consist of all of the apertures of the distal wheel. The features of the set of apertures of the distal wheel may be transposed and applied to the set of apertures of the starter wheel and to the set of apertures of the intermediate wheel.

According to the invention, a mechanical transmission system comprising a DCRR according to the invention is also proposed.

According to the invention, a bike comprising a DCRR according to the invention is also proposed.

### DESCRIPTION OF THE FIGURES

Other advantages and particularities of the invention will appear upon reading the detailed description of non-limiting implementations and embodiments, and from the following appended drawings:

FIG. 1 is a schematic illustration in perspective view of an embodiment of the DCRR according to the invention,

FIG. 2 is a schematic illustration in exploded view of the DCRR according to a first advantageous improvement,

FIG. 3 is a schematic illustration in perspective view of the distal wheel of the DCRR according to the first improvement,

FIG. 4 is a schematic illustration in perspective view of the proximal wheel of the DCRR according to the first improvement,

FIG. 5 is a schematic illustration in exploded perspective view of the DCRR according to a second improvement of the embodiment,

FIG. 6 is a schematic illustration in perspective view of the starter wheel of the distal wheel according to the second improvement of the embodiment,

FIG. 7 is a schematic illustration in perspective view of the intermediate wheel of the distal wheel according to the second improvement of the embodiment,

FIGS. 8A and 8B are schematic illustrations in perspective view of the DCRR according to the embodiment on which a crank is mounted.

### DESCRIPTION OF THE EMBODIMENTS

The embodiments described hereinafter being in no way restrictive, variants of the invention comprising only a selection of the described features, isolated from the other described features (even though this selection is isolated within a sentence comprising these other features) could be considered in particular, if this selection of features is sufficient to confer a technical advantage or to differentiate the invention with regards to the prior art. This selection comprises at least one feature, preferably functional without structural details, or with only part of the structural details if this portion alone is sufficient to confer a technical advantage or to differentiate the invention with regards to the prior art.

The disclosed embodiment relates to bikes or bicycles. In particular, the invention relates to the BMX field. Nonetheless, the invention is not limited to the particular application field of bikes and bicycles.

Existing technologies consist essentially of derailleurs and continuous variable transmission systems. In cycling, the transmission ratio is assimilated to the gear ratio conventionally defined as the ratio between the number of teeth of the toothed wheel of the crankset, so-called the plate, and that of the toothed wheel of the rear hub, so-called the pinion. This ratio is theoretically equivalent to the ratio of the primitive radii of the plate and of the pinion. There are cycling events for which the cyclists do not use a ratio changing device, for lack of a technical solution suited to the specificity of their discipline. They are constrained to use only one single transmission ratio, the latter then results from a trade-off between a low ratio, favourable to the starting phase, and a higher ratio, favourable to the continuation of pedalling when higher rates can be developed. Consequently, the pedalling rate is necessarily too low during the first instants and then rapidly it becomes too high, which, in the 2 cases, compromise the generation of a maximum power.

All of the advantages/drawbacks of these devices are synthesised in Table 1.

TABLE 1

| | | Ratio | | Mass | | Possibility |
|---|---|---|---|---|---|---|
| | | change | Mechanical | and | Manual | of repeated |
| Technologies | Discontinuities | under load | efficiency | inertia | intervention | changes |
| Derailleurs | YES | NO | VERY | LOW | YES | YES |
| | | | GOOD | | | |
| Hub | YES | NO | GOOD | HIGH | YES | YES |
| gear | | | | | | |
| Gear- | YES | YES/NO | GOOD | HIGH | YES/NO | YES |
| box | | (DEPENDING | | | (DEPENDING | |
| | | ON THE | | | ON THE | |
| | | TECHNOLOGY) | | | TECHNOLOGY) | |
| CVT | NO | YES | GOOD | HIGH | NO | YES |
| Present | NO | YES | VERY | LOW | NO | NO |
| invention | | | GOOD | | | |

The DCRR 1 according to the invention allows overcoming most of the drawbacks of the devices of the prior art. In particular, as shown in Table 1, the DCRR 1 enables a change in the reduction ratio under load, without discontinuity and without any manual intervention. On the other hand, and unlike the other devices, the change in the transmission ratio of the DCRR according to the invention is automatic, it is not possible to intervene to modify it when the device is in use. Furthermore, the change in ratio is performed in only one direction, or the DCRR is arranged so as to increase the transmission ratio or to reduce it.

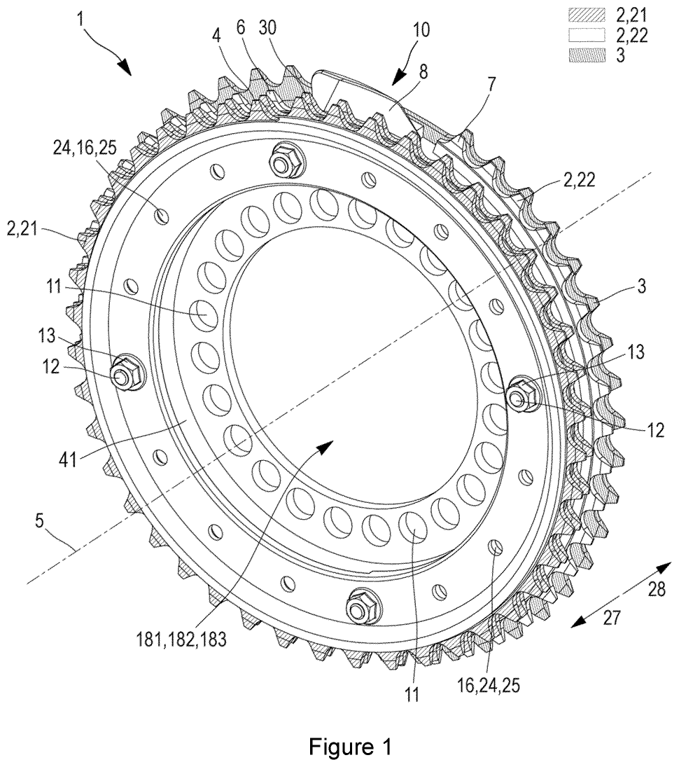

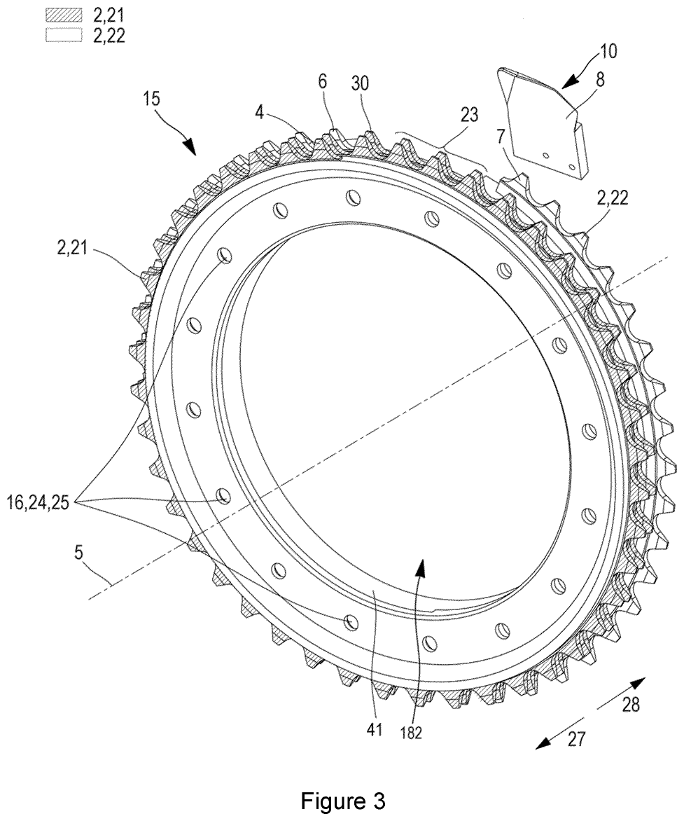

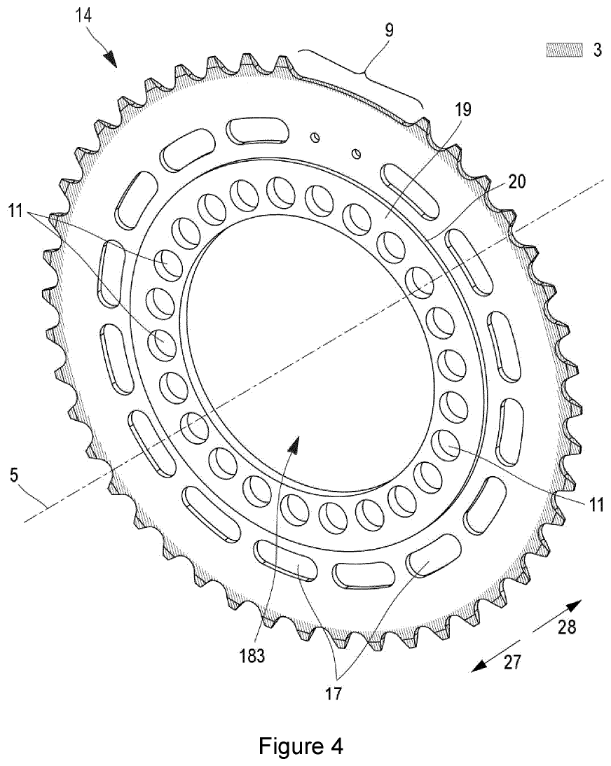

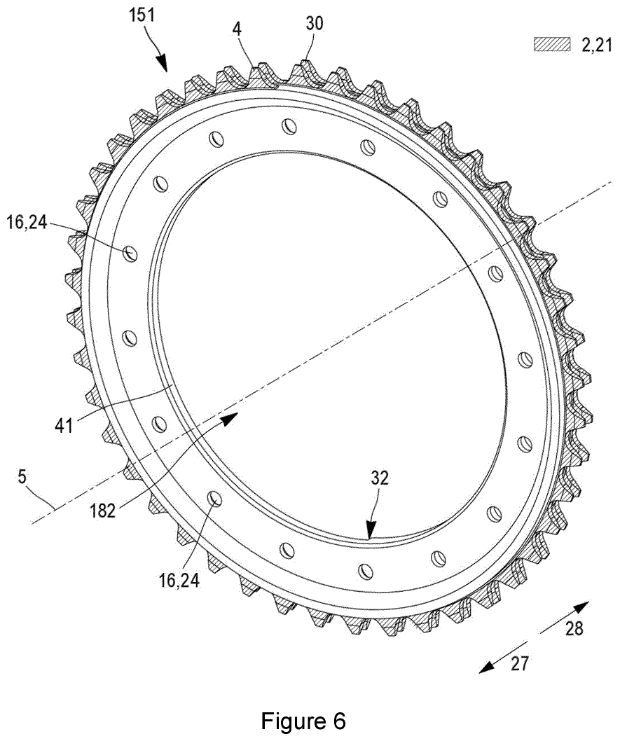

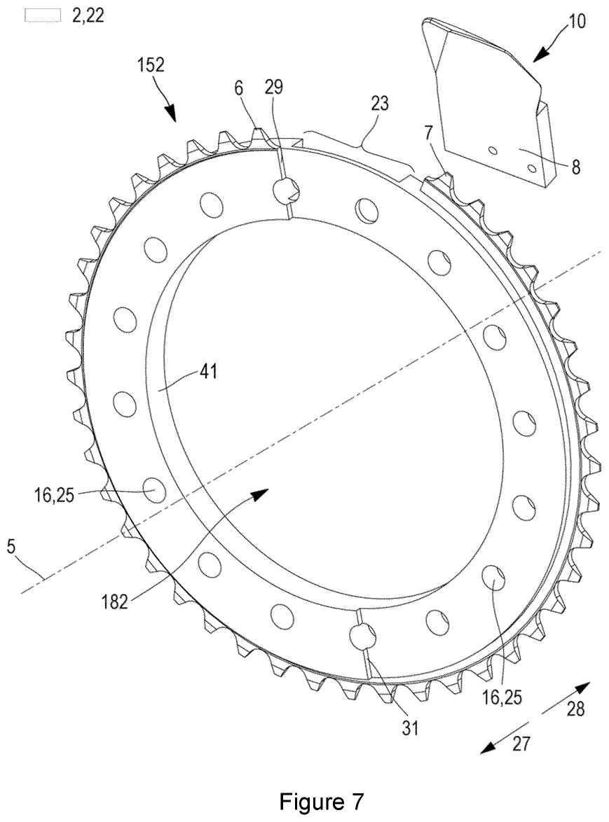

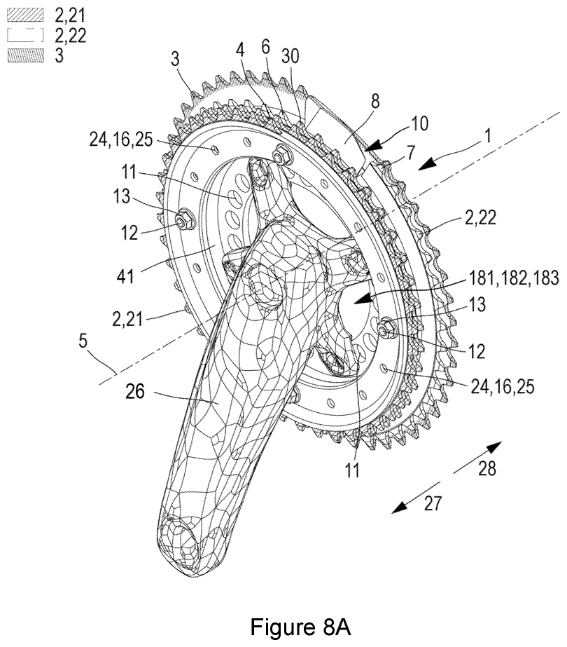

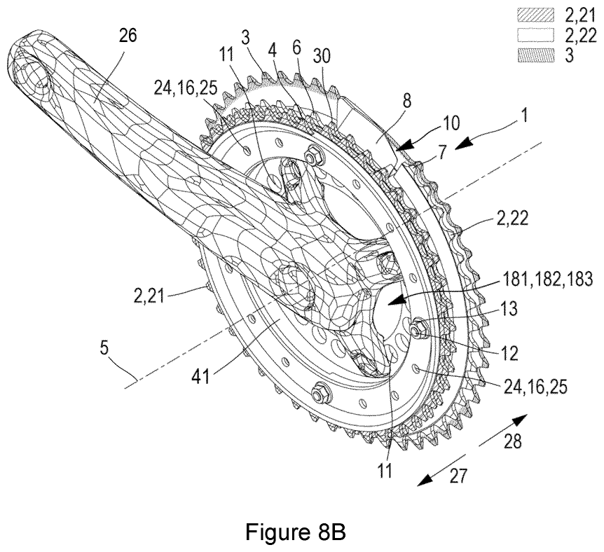

Referring to FIGS. 1 to 8, an embodiment of the invention is described. FIG. 1 illustrates a DCRR 1 for a chain transmission according to the invention. The DCRR 1 is intended to be meshed with a chain which is not shown because it does not form part of the invention or of the DCRR 1. The arrows referenced 27 and 28 point towards the direction or the side or the distal section of the DCRR 1 and respectively the direction or the side or the proximal section of the DCRR 1.

Referring to FIGS. 1 to 8, an embodiment of the DCRR 1 is described. The DCRR 1 comprises a toothing 2, 3. The toothing 2, 3 comprises a portion 2, so-called the helical portion 2, forming a toothed helix winding around an axis of revolution 5 of the DCRR 1. The toothing 2, 3 also comprises a portion 3, so-called the circular portion 3, forming a toothed planar circle, whose centre coincides with the axis of revolution 5 of the DCRR 1. The helical portion 2 of the toothing 2, 3 extends from a distal end 4, or distal end tooth 4, of the toothing of the DCRR 1 towards the circular portion 3 of the toothing 2, 3. The circular portion 3 of the toothing 2, 3 forms a proximal end 3 of the toothing 2, 3 of the DCRR 1. The circular portion 3 of the toothing 2, 3 is arranged so as to keep a constant reduction ratio. Preferably, the circular portion 3 of the toothing 2, 3 is arranged so as to offer an input resistance corresponding to that of the input rotational speed approaching the maximum efficiency point of the cyclist. The helical portion 2 is arranged so as to enable an increase in the rotational speed of the DCRR 1 and to ensure an increase in the reduction ratio. Preferably, the increase in the rotational speed of the DCRR 1 and in the reduction ratio are adapted according to the morphology of the cyclist, to the topography of the pathway and/or to the race strategy.

The fact that the helical portion extends from the distal end 4 of the DCRR 1 up to the proximal end 3, i.e. the circular portion 3, of the toothing 2, 3 allows initiating the rotation of the DCRR 1, and therefore of the bike by increasing the rotational speed of the DCRR 1 and the reduction ratio automatically (without the need for actuating a manual control) and continues under load, without discontinuity and smoothly. The fact that the DCRR 1 according to the invention does not generate any passage discontinuity or jump from a circular portion to another circular portion or to an helix during this phase (increase in the rotational speed of the DCRR 1 and in the reduction ratio) allows improving the properties of the DCRR 1 and therefore the performances of the cyclist. To this end, the number of teeth of the helical portion 2 is preferably greater than the number of teeth of the circular portion 3.

The DCRR 1 comprises a guide 8 arranged between the proximal end 7 of the toothing of the helical portion 2 and the toothing of the circular portion 3. The guide 8 is arranged so as to contribute to and/or participate in a continuous meshing of the chain with the DCRR 1, from the helical portion 2 towards the circular portion 3. The guide 8 enables a passage of the chain from the helical portion 2 towards the circular portion 3 under load, without overlap and smoothly. Furthermore, the fact that the helical portion 2 extends from the distal end 4 of the DCRR 1 up to the proximal end 3 of the toothing implies that the passage from the helical portion 2 towards the circular portion 3 is performed while the cyclist has already reached or is close to his/her optimum rotation rate.

The toothing of the circular portion 3 comprises a recess 9 of at least one tooth opposite which the guide 8 is arranged. According to the invention, three teeth are absent from the recess formed in the toothing of the circular portion 3. This recess 9 allows limiting the risks of overlap and reduces the chances of damaging the chain.

A portion of a proximal surface 10 of the guide 8 is arranged so as to ensure guidance of the chain from the helical portion 2 towards the circular portion 3. Preferably, the proximal surface 10 of the guide 8 is arranged so as to guide, by friction, the chain according to the axis of revolution 5 of the DCRR 1, or a direction connecting the helical portion 2 to the circular portion 3.

The DCRR 1 comprises a set of contiguous orifices 11 equidistant from the axis of revolution 5 of the DCRR 1 which are symmetrical in pairs with respect to the axis of revolution 5 of the DCRR 1. The orifices 11 are arranged so as to ensure fastening of the cranks or pedals 26 on the DCRR 1. The cranks 26 are not part of the DCRR 1. The orifices 11 border the central opening 181 of the DCRR 1. The orifices are distributed so as to allow adapting or adjusting the angular position of the pedals 26 on the DCRR 1. The angular position is adjusted relative to the elements of the DCRR 1, such as the distal 4 and/or proximal 3 ends of the DCRR 1 and/or the proximal end 30 of the toothing of the first section 21 of the helical portion 2 and/or the distal end 7 of the toothing of the second section 22 of the helical portion 2. Preferably, the angular position of the pedals 26 is adjusted with regards to the morphology of the cyclist, to the topography of the pathway and/or to the race strategy.

According to an advantageous configuration of the embodiment, the radius of the helical portion 2 is constant over the section 21, so-called the first section 21, of the helical portion 2 and/or varies over the section 22, so-called the second section 22, of the helical portion 2.

In this advantageous configuration, the helical portion 2 is arranged so as to ensure a rapid increase in the rotational speed of the DCRR 1. Preferably, the increase in the rotational speed of the DCRR 1 is carried out at a constant reduction ratio. The rotational speed is increased, and preferably the reduction ratio is kept constant, at least over one turn of the helix of the helical portion 2. To this end, the toothed helix of the first section 21 of the helical portion 2 winds at least one turn around the axis of revolution 5 of the DCRR 1, one turn and a half according to the embodiment.

In this advantageous configuration, the helical portion 2 is also arranged so as to increase the reduction ratio. Hence, the helical portion 2 is arranged so as to enable an increase in the rotational speed of the DCRR 1 and then to ensure an increase in the reduction ratio. In particular, the helical portion 2 is arranged so as to increase the reduction ratio after the rotational speed of the DCRR 1 has reached a desired value, and/or that the chain meshing with the DCRR 1 has covered a desired number of turns along the helix of the helical portion 2. To this end, the radius of the second section 22 of the helical portion 2 increases along the axis of revolution 5 according to a direction extending from a distal end 6 of the toothing 2, 3 of the second section 22 of the helical portion 2 towards a proximal end 7 of the toothing 2, 3 of the second section 22 of the helical portion 2.

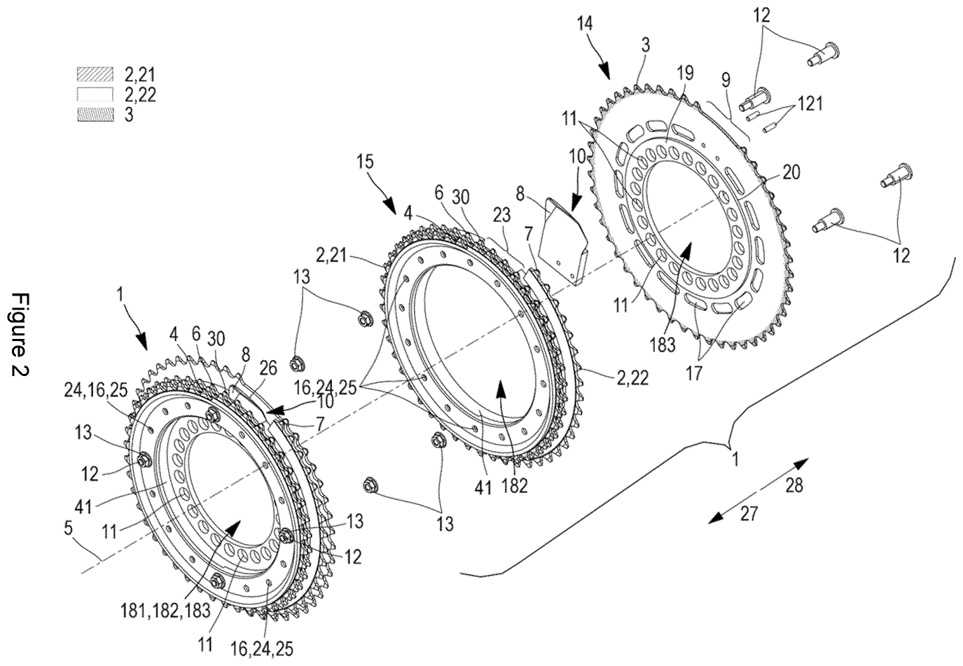

Referring to FIGS. 2 to 4, and according to a first improvement of the invention, each of the circular portion 3 and the helical portion 2 is part of a distinct part of the DCRR 1. These distinct parts are arranged so as to be reversibly assembled, by fastening means 12, 13, in one-piece so as to form the DCRR 1 after assembly. The part comprising the circular portion 3 is so-called the proximal wheel 14 and the part comprising the helical portion 2 is so-called the distal wheel 15. This improvement allows making the DCRR 1 modular by substituting, on site, for example during a competition, either one of the wheels as needed. The fastening means 12, 13 consist of a screw 12 and a nut 13.

According to the first improvement, the distal wheel 15 comprises a set of contiguous apertures 16 equidistant from the axis of revolution 5 of the DCRR and symmetrical in pairs with respect to the axis of revolution 5 of the DCRR 1. The proximal wheel 14 comprises a set of contiguous apertures 17 equidistant from the axis of revolution 5 of the DCRR 1 and symmetrical in pairs with respect to the axis of revolution 5 of the DCRR 1. Each of the apertures 17 of the set of apertures of the proximal wheel 14 has a curved shape extending according to a circle arc parallel to the circular portion 3. A radius of the circular arc according to which the apertures 17 of the set of apertures of the proximal wheel 14 extend is equal to a distance between the axis of revolution 5 of the DCRR 1 and the centres of the apertures 17 of the set of apertures of the distal wheel 15 so as to adjust an angular position of the proximal wheel 14 relative to the distal wheel 15. Also, the change or replacement of one of the wheels 14, 15 is simple, rapid and could be performed on site via the adjustment of the angular position enabled by the apertures 16, 17.

According to the first improvement, the DCRR 1 comprises a central opening 181. The proximal wheel 14 of the DCRR 1 comprises a radial projection 19 forming a ring 19 comprising a radial peripheral wall 20. The ring 19 forms an extra thickness, extending according to the axis of revolution 5 of the DCRR 1, of the proximal wheel 14. The ring 19 extends radially from the central opening 183 of the proximal wheel 14 up to the radial peripheral wall 20. The ring 19 is arranged so as to be inserted into the central opening 182 of the distal wheel 15. The radial peripheral wall 20 is arranged so as to be supported bearing on the walls 41 of the distal wheel 15 delimiting the central opening 182 of the distal wheel 15. This radial projection 19 facilitates the assembly of the proximal 14 and distal 15 wheels. Furthermore, the radial projection 19 prevents the translation of the proximal 14 and distal 15 wheels relative to one another. Finally, the radial projection 19 allows improving the robustness of the DCRR 1.

According to the first improvement, the guide 8 is reversibly fastened, by fastening means 121, pins 121 according to the embodiment, on the proximal wheel 14 and the distal wheel 15 comprises a notch 23 arranged so as to accommodate, at least in part, the guide 8.

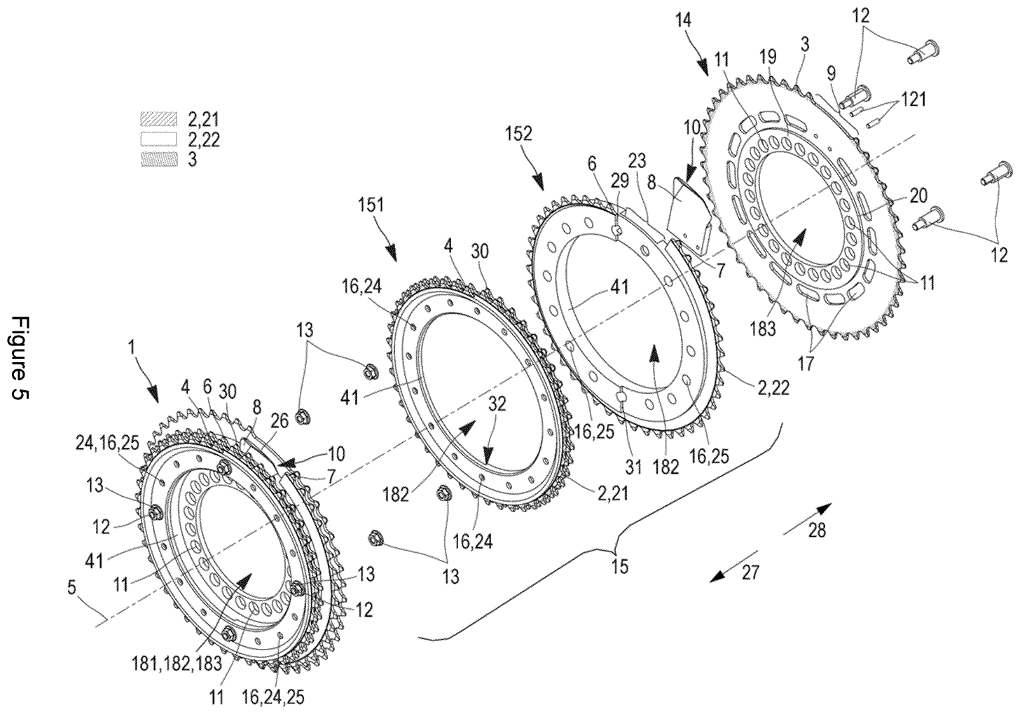

Referring to FIGS. 5 to 7, and according to a second improvement of the invention, the distal wheel 15 is formed of two distinct parts, one of the two parts, so-called the starter wheel 151, comprises the first section 2,21 of the helical portion 2 and the other of the two parts, so-called the intermediate wheel 152, comprises the second section 2,22 of the helical portion 2. This improvement allows making the DCRR 1 modular by substituting, on site, for example during a competition, either one of the wheels as needed. Combined with the first improvement, it confers even more modularity on the DCRR 1. The starter 151 and the intermediate 152 wheels are arranged so as to be reversibly assembled in one-piece so as to form the DCRR 1 after assembly. The starter 151 and the intermediate 152 wheels are arranged so as to be assembled by the fastening means 12, 13. Furthermore, the shank of the screws 12 has two different diameters. A larger diameter, located on the side of the head of the screw, close to the diameter of the apertures 25 of the intermediate wheel 152 and a smaller diameter, located on the side opposite to the side comprising the head of the screw, close to the diameter of the apertures 24 of the starter wheel 151.

According to the second improvement of the invention, each of the starter wheel 151 and the intermediate wheel 152 comprises a set of contiguous apertures 24, 25 equidistant from the axis of revolution 5 of the DCRR 1 and symmetrical in pairs with respect to the axis of revolution 5 of the DCRR 1. A distance between the axis of revolution 5 of the DCRR 1 and the centres of the apertures 24 of the set of apertures 24 of the starter wheel 151 is equal to a distance between the axis of revolution 5 of the DCRR 1 and the centres of the apertures 25 of the set of apertures 25 of the intermediate wheel 152.

The intermediate wheel 152 comprises a distal end wall 29. The distal end wall 29 extends according to a plane comprising the axis of revolution 5 of the DCRR 1. In other words, the axis of revolution 5 of the DCRR 1 is comprised in the plane according to which the distal end wall 29 of the intermediate wheel 152 extends. The distal end wall 29 of the intermediate wheel 152 extends from the distal end 6 of the intermediate wheel 152. The intermediate wheel 152 also comprises a wall 31, so-called the complementary wall 31, comprised in the same plane as the distal end wall 29 of the intermediate wheel 152. The complementary wall 31 is located on the side opposite to the distal end wall 29 of the intermediate wheel 152 with respect to the axis of revolution 5 of the DCRR 1.

The starter wheel 151 comprises a proximal end wall (not visible). The proximal end wall of the starter wheel 151 extends according to a plane comprising the axis of revolution 5 of the DCRR 1. In other words, the axis of revolution 5 of the DCRR 1 is comprised in the plane according to which the proximal end wall of the starter wheel 151 extends. The proximal end wall of the starter wheel 151 is comprised in the same plane as that in which the distal end wall 29 extends. The starter wheel 151 also comprises a wall 32, so-called the complementary wall 32 of the proximal end wall of the starter wheel 151, comprised in the same plane as the proximal end wall of the starter wheel 151. The complementary wall 32 of the proximal end wall of the starter wheel 151 is located on the side opposite to the proximal end wall of the starter wheel 151 with respect to the axis of revolution 5 of the DCRR 1.

The distal end wall 29 of the intermediate wheel and the complementary wall 31 of the distal end wall 29 are arranged so as to be brought into abutment with, respectively, the proximal end wall of the starter wheel 151 and the complementary wall 32 of the proximal end wall of the starter wheel 151. The cooperation between these different walls facilitates the assembly of the starter 151 and intermediate 152 wheels. Furthermore, this cooperation prevents the rotation of the starter wheel 151 relative to the intermediate wheel 152. Finally, this cooperation allows improving the robustness of the DCRR 1.

The first improvement can be carried out independently of the second improvement and does not require the implementation of the second improvement. The second improvement is combined with the first improvement.

Of course, the invention is not limited to the examples that have just been described and numerous arrangements could be made to these examples without departing from the scope of the invention.

In addition, the different features, shapes, variants and embodiments of the invention may be associated with each other according to various combinations to the extent that they are not incompatible or exclusive of one another.

1. A reduction ratio changing device, so-called DCRR, for a mechanical chain transmission system, said DCRR comprises a toothing, said toothing of the DCRR comprises:
a portion, so-called the helical portion, forming a toothed helix winding around an axis of revolution of the DCRR,
a portion, so-called the circular portion, forming a toothed planar circle whose centre coincides with the axis of revolution of the DCRR,
the helical portion of the toothing extends from a distal end of the toothing of the DCRR towards the circular portion of the toothing, said circular portion of the toothing forming a proximal end of the toothing of the DCRR.

2. The DCRR according to claim 1, wherein a number of teeth of the helical portion is greater than a number of teeth of the circular portion.

3. The DCRR according to claim 1, wherein a radius of the helical portion is constant over at least one section, a so-called first section, of the helical portion and/or a radius of the helical portion varies over at least one section, a so-called second section, of the helical portion.

4. The DCRR according to claim 1, wherein the toothed helix of the first section of the helical portion winds at least one turn around the axis of revolution of the DCRR.

5. The DCRR (1) according to claim 3, wherein the radius of the second section of the helical portion increases along the axis of revolution according to a direction extending from a distal end of a toothing of the second section of the helical portion towards a proximal end of the toothing of the second section of the helical portion.

6. The DCRR according to claim 1, comprising a guide arranged between a proximal end of a toothing of the helical portion and a toothing of the circular portion, said guide being arranged so as to ensure a continuous meshing, of a chain with which the DCRR is intended to be meshed, from the helical portion towards the circular portion.

7. The DCRR according to claim 1, wherein the toothing of the circular portion comprises a recess of at least one tooth opposite which the guide is arranged.

8. The DCRR according to claim 1, wherein a portion of a proximal surface of the guide is arranged so as to guide the chain, with which the DCRR is intended to be meshed, from the helical portion to the circular portion.

9. The DCRR according to claim 1, comprising a set of contiguous orifices equidistant from the axis of revolution of the DCRR, symmetrical in pairs with respect to the axis of revolution of the DCRR, being arranged so as to ensure fastening of transmission elements on the DCRR; the transmission elements are intended to be fastened on the DCRR and to transmit the force torque to the DCRR.

10. The DCRR according to claim 1, wherein each of the circular portion and the helical portion is part of a distinct part, said distinct parts are arranged so as to be reversibly assembled by screws and nuts, in one-piece so as to form the DCRR; the part comprising the circular portion is so-called the proximal wheel and the part comprising the helical portion is so-called the distal wheel.

11. The DCRR according to claim 10, wherein:
the distal wheel comprises a set of contiguous apertures equidistant from the axis of revolution of the DCRR and symmetrical in pairs with respect to the axis of revolution of the DCRR,
the proximal wheel comprises a set of contiguous apertures equidistant from the axis of revolution of the DCRR and symmetrical in pairs with respect to the axis of revolution of the DCRR;
each of the apertures of the set of apertures of the proximal wheel, or respectively of the distal wheel, has a curved shape extending according to a circle arc parallel to the circular portion, and
a radius of the circle arc according to which the apertures of the set of apertures of the proximal wheel, or respectively of the distal wheel, extend, is equal to a distance between the axis of revolution of the DCRR and centres of the apertures of the set of apertures of the distal wheel, or respectively of the proximal wheel, so as to adjust an angular position of the proximal wheel relative to the distal wheel.

12. The DCRR according to claim 10, wherein the distal wheel of the DCRR comprises a central opening and wherein the proximal wheel of the DCRR comprises a radial projection forming a ring comprising a radial peripheral wall, said ring forming an extra thickness, extending according to the axis of revolution of the DCRR, of the proximal wheel and being arranged so as to be inserted into the central opening of the distal wheel; the radial peripheral wall is arranged so as to be supported bearing on the walls of the distal wheel delimiting the central opening of the distal wheel.

13. The DCRR according to claim 6, wherein the guide is reversibly fastened by pins on the proximal wheel, or respectively distal wheel, and the distal wheel, or respectively the proximal wheel, comprises a notch arranged so as to accommodate, at least in part, the guide.

14. The DCRR according to claim 13, wherein the distal wheel is formed of two distinct parts, one of the two parts, so-called the starter wheel, comprises the first section of the helical portion and the other of the two parts, so-called the intermediate wheel, comprises the second section of the helical portion.

15. The DCRR according to claim 14, wherein each of the starter wheel and the intermediate wheel comprises a set of contiguous apertures equidistant from the axis of revolution of the DCRR and symmetrical in pairs with respect to the axis of revolution of the DCRR; a distance between the axis of revolution of the DCRR and the centres of the apertures of the set of apertures of the starter wheel is equal to a distance between the axis of revolution of the DCRR and the centres of the apertures of the set of apertures of the intermediate wheel.

16. The DCRR according to claim 6, wherein each of the circular portion and the helical portion is part of a distinct part, said distinct parts are arranged so as to be reversibly assembled by screws and nuts, in one-piece so as to form the DCRR; the part comprising the circular portion is so-called the proximal wheel and the part comprising the helical portion is so-called the distal wheel.

17. The DCRR according to claim 3, wherein each of the circular portion and the helical portion is part of a distinct part, said distinct parts are arranged so as to be reversibly assembled by screws and nuts, in one-piece so as to form the DCRR; the part comprising the circular portion is so-called the proximal wheel and the part comprising the helical portion is so-called the distal wheel.

18. The DCRR according to claim 17, wherein:
the distal wheel comprises a set of contiguous apertures equidistant from the axis of revolution of the DCRR and symmetrical in pairs with respect to the axis of revolution of the DCRR,
the proximal wheel comprises a set of contiguous apertures equidistant from the axis of revolution of the DCRR and symmetrical in pairs with respect to the axis of revolution of the DCRR;
each of the apertures of the set of apertures of the proximal wheel, or respectively of the distal wheel, has a curved shape extending according to a circle arc parallel to the circular portion, and a radius of the circle arc according to which the apertures of the set of apertures of the proximal wheel, or respectively of the distal wheel, extend, is equal to a distance between the axis of revolution of the DCRR and centres of the apertures of the set of apertures of the distal wheel, or respectively of the proximal wheel, so as to adjust an angular position of the proximal wheel relative to the distal wheel.
